(19) United States
(12) Patent Application Publication
(10) Pub. No.: US 2011/0047562 A1
(43) Pub. Date: Feb. 24, 2011

(54) SPINDLE MOTOR HAVING BALL BALANCER

(75) Inventor: Yongjoo Kim, Seoul (KR)

Correspondence Address: SALIWANCHIK LLOYD & SALIWANCHIK;A PROFESSIONAL ASSOCIATION, PO Box 142950, GAINESVILLE, FL, 32614, US

(73) Assignee: LG INNOTEK CO., LTD., Seoul (KR)

(21) Appl. No.: 12/862,355

(22) Filed: Aug. 24, 2010

(30) Foreign Application Priority Data
Aug. 24, 2009 (KR) 10-2009-0078024

(51) Int. Cl. G11B 19/20

(52) U.S. Cl. 720/701; G9B/19.027

(57) ABSTRACT

Disclosed is a spindle motor including a turn table on which a disk is mounted; a rotation shaft that is a rotational center of the turn table; and a ball balancer including a lace formed on the turn table and a ball stored in the lace in order to reduce a rotation vibration of the disk; wherein a gap Gr formed between the ball contacting an inner surface of the lace adjacent to the rotation shaft and an outer surface of the lace facing the inner surface is about 10% to 20% of the diameter of the ball.

### CROSS-REFERENCE TO RELATED APPLICATION

This application claims the benefit under 35 U.S.C. §119 of Korean Patent Application No. 10-2009-0078024, filed on Aug. 24, 2009, which is hereby incorporated by reference in its entirety.

### BACKGROUND

1. Field of the Invention

The present disclosure relates to a spindle motor including a ball balancer configured to reduce a vibration occurring in an optical disk drive device.

2. Description of the Related Art

A spindle motor includes a rotation shaft that is rotationally inserted into a bearing, a rotor coupled with the rotation shaft and rotated, a stator having coils wound therearound, the coil generating electromagnetic force with the rotor, a base plate to support the stator, and a bearing housing fixed to the base plate and support the bearing.

In a case an ‘eccentric disk’ having an eccentric mass is loaded in the spindle motor, a vibration is generated in the spindle motor due to the eccentric disk and then an error may occur in the optical disk drive, the eccentric mass being caused by the fact that a geometric center of the disk is dislocated or a label is attached to the disk.

In order to reduce the vibration caused in the spindle motor, the turn table has a ball balancer mounted thereon. The ball balancer is a space in which a ball having a desired mass can roll freely, which has a lace arranged on the turn table. When the turn table rotates together with the disk, the ball moves in the opposite direction of the eccentric mass at a revolution corresponding to a mechanical intrinsic frequency of the optical disk drive device having a spindle motor mounted thereon, thereby reducing the vibration.

To this end, an internal condition of the lace should be constructed to allow the ball to roll freely. However, there is a disadvantage in the prior art in that a space between the ball and the lace is relatively too small to prevent the ball from rolling smoothly, whereby the vibration reduction effect is insufficient.

### BRIEF SUMMARY

According to the present disclosure, there is provided a spindle motor that has an enhanced ball rolling and a maximized vibration reduction effect by optimizing a space between a ball and a lace relatively.

According to an aspect of the present disclosure, a spindle motor may include a turn table on which a disk is mounted; a rotation shaft that is a rotational center of the turn table; and a ball balancer including a lace formed on the turn table and a ball stored in the lace in order to reduce a rotation vibration of the disk; wherein a gap Gr formed between the ball contacting an inner surface of the lace adjacent to the rotation shaft and an outer surface of the lace facing the inner surface is about 10% to 20% of the diameter of the ball.

According to another aspect of the present disclosure, a spindle motor may include a turn table on which a disk is mounted; a rotation shaft that is a rotational center of the turn table; and a ball balancer including a lace formed on the turntable, a ball stored in the lace, a cover to cover the lace and a friction member interposed between the ball and the cover, in order to reduce a rotation vibration of the disk; wherein a gap Gz formed between the ball arranged on the friction member and the top plane of the lace contacting the friction member is about 10% to 20% of the diameter of the ball.

According to yet another aspect of the present disclosure, a spindle motor includes a turn table on which a disk is mounted; a rotation shaft that is a rotational center of the turn table; and a ball balancer including a lace formed on the turntable, a ball stored in the lace, a cover to cover the lace and a friction member interposed between the ball and the cover, in order to reduce a rotation vibration of the disk; wherein a gap Gr formed between the ball contacting an inner surface of the lace adjacent to the rotation shaft and an outer surface of the lace facing the inner surface and a gap Gr formed between the ball arranged on the friction member and the top plane of the lace contacting the friction member are about 10% to 20% of the diameter of the ball, respectively.

### BRIEF DESCRIPTION OF THE DRAWINGS

The accompanying drawings, which are included to provide a further understanding of the disclosure and are incorporated in and constitute a part of this application, illustrate embodiments of the disclosure and together with the description, serve to explain the principle of the disclosure. In the drawings:

FIG. 1 is a side sectional view showing a spindle motor including a ball balancer of the present disclosure.

FIG. 2 is a plane view that briefly shows a ball balancer structure according to the present disclosure.

FIG. 3 is a graphical view explaining an effect of the ball balancer 200 which is applied to the present disclosure.

### DETAILED DESCRIPTION

Hereinafter, an embodiment of the present disclosure will be described with reference to the accompanying drawings.

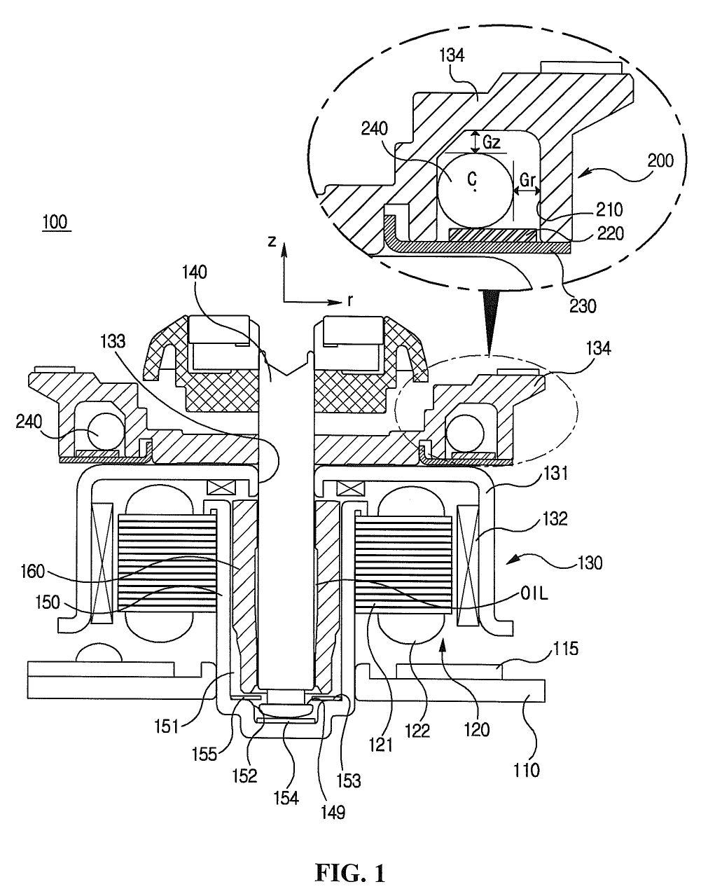

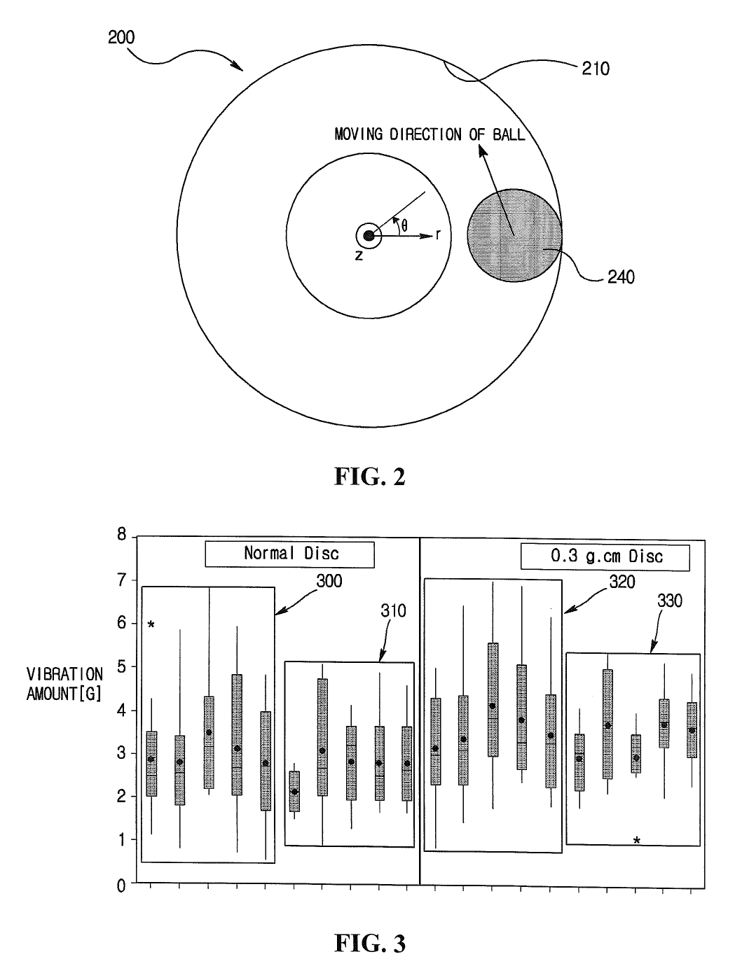

FIG. 1 is a side sectional view showing a spindle motor including a ball balancer of the present disclosure. FIG. 2 is a plane view that briefly shows a ball balancer structure according to the present disclosure. Structure and operation of the spindle motor including a ball balancer according to the present disclosure will be described with reference to FIGS. 1 and 2.

Prior to description of the present disclosure, a cylindrical coordinate system of the spindle motor 100 will be defined. A radial direction of a turn table of the spindle motor 100 is defined as r axis, a tangential direction of the turn table is defined as θ axis and an axial direction of the rotation shaft coupled with the turn table is defined as z axis.

The spindle motor 100 includes a base plate 110, a stator 120, a rotor 130, a rotation shaft 140 and a bearing housing 150.

A circuit board 115 is coupled with the top plane of the base plate 110. The housing 150 has the base plate 110 coupled therethrough, and a pipe-shaped bearing 160 is arranged in the bearing housing 150.

The bearing housing 150 has a bearing receiving groove 151 a thrust plate receiving groove 152 formed therein.

The bearing 160 is inserted into the bearing receiving groove 151, and the thrust plate 154 is arranged in the thrust plate receiving groove 152.

The thrust plate 154 serves to prevent a friction from generating between the rotation shaft 140 and the bearing housing 150 and to support vertical weight of the rotation shaft 140, which is interposed between the bottom and the bottom plane of the bearing housing 150. The width of the thrust plate receiving groove 152 is smaller than that of the bearing receiving groove 151.

A stopper seating member 153 is arranged between the bearing receiving groove 151 and the thrust plate receiving groove 152. The stopper 155 having a washer shape is arranged in the stopper seating member 153.

The stopper 155 prevents the rotation shaft 140 from being lifted and leaving the bearing 160 when the disk is rotated. The stopper 155 is hooked to a stopper groove 149 of the rotation shaft 140 and a bottom of the bearing 160 so that it suppresses the lift of the rotation shaft 140.

The stator 120 is fixed to the bearing housing 150. The stator 120 includes a core 121 fixed to the bearing housing 150 and a coil 122 wound around the coil 121.

The rotation shaft 140 is arranged in the bearing 160 and the rotation shaft 140 is rotationally coupled with the bearing 160.

A fine gap is formed between the inner surface of the bearing 160 and the outer surface of the rotation shaft 140 and has oil received therein. Tolerance of the gap is determined in the range not to interrupt the rotation of the rotation shaft and to meet the axis swing or run-out of the rotation shaft.

The rotor 130 includes a rotor yoke 131 coupled with the rotation shaft 140 and a magnet 132 arranged in the inner surface of the rotor yoke 131. A coupling groove 133 is formed in the center of the top plane of the rotor yoke 131 and the rotation shaft 140 is pressed into the coupling groove 133.

The turn table 134 on which a disk is safely seated is arranged on the top plane of the rotor yoke 131.

When current is applied to the coil 122, the rotor 130 rotates together with the rotation shaft 140 by the electromagnetic force generated between the stator 120 and the magnet 132.

The ball balancer 200 formed on the turn table 134 reduces vibration occurred according to the rotation of the eccentric disk. While the turn table 134 and the ball balancer 200 are integrally formed according to an embodiment of the present disclosure, they may not be integrally formed.

The ball balancer 200 includes a lace in which a ball is stored and a ball 240, in order that the ball 240 can be rolled freely.

It is desirable that the ball 240 has a sphere shape close to a perfect sphere. The lace 210 includes a vacant space formed along with a circumferential direction of the turn table, and has an open bottom to insert the ball 240 therethrough.

The opening of the lace 210 formed to insert the ball 240 is covered with a cover 230 after inserting the ball 240. The number of the ball 240 is determined in proportional to the magnitude of the corresponding eccentric mass.

The ball balancer 200 to control the rotation speed of the spindle motor 100 and the rolling speed of the ball 240 may further include a friction member 220 to provide a friction force to accelerate or stop the ball 240 correspondingly to the rotation speed of the turn table of the spindle motor 100 and a cover 230 to cover the lace. The friction member 220 is attached to the cover 230, for example

The lace 210 is formed in a circular trench shape starting from the bottom of the turn table 134. Hereinafter, a portion facing the cover 230 of the lace 210 is defined as an top plane, an inner side of the lace 210 adjacent to the rotation shaft 140 is defined as an inner surface, and an inner side of the lace 210 facing the inner surface is defined as an outer surface.

The cover 230 seals the lace 210 by covering the bottom of the turn table 134.

According to an embodiment of the present disclosure, the vibration occurring in the spindle motor can be largely reduced by controlling the diameter of the ball 240 and the relative size of the lace 210 with respect to the diameter of the ball 240.

A first gap Gr formed between the lace 210 and the ball 240 with reference to the radial direction and/or a second gap Gz formed between the ball 240 and the lace 210 in the axial direction of the rotation shaft 140 may be about 10% to 20% of the diameter of the ball 240.

In detail, a separation distance between the ball 240 contacted with the inner surface of the lace 210 and the outer surface facing the inner surface of the lace 210 is defined as a first gap Gr, and the first gap Gr may be about 10% to 20% of the diameter of the ball 240.

According to an embodiment of the present disclosure, when the first gap Gr is equal to or smaller than 10% of the diameter of the ball 240, a vibration caused by the rotation of the turn table 134 of the spindle motor may be occurred, and when the gap Gr is equal to or greater than 20% of the diameter of the ball 240, the diameter of the turn table 134 may be increased.

Further, a separation distance between the ball 240 arranged on the friction member 220 and the top plane of the lace 210 contacted with the ball 240 is defined as a second gap Gz, and the second gap Gz may be about 10% to 20% of the diameter of the ball 240.

According to an embodiment of the present disclosure, when the second gap Gz is equal to or smaller than the diameter of the ball 240, a vibration caused by the rotation of the turn table 134 of the spindle motor, and when the gap Gz is equal to or greater than 20% of diameter of the ball 240, the height of the turn table 134 may be increased.

FIG. 3 is a graphical view explaining an effect of the ball balancer 200 which is applied to the present disclosure.

In a comparative embodiment used to compare with the present disclosure, a ball inserted into a lace of the turn table has a diameter of about 2.5 mm, and a first gap Gr and a second gap Gz are about 2% to 6% of the diameter of the ball inserted into the lace, that is, about 0.05 mm to 0.15 mm.

In the comparative embodiment, the first and second gaps Gr and Gz are 0.1 mm, that is, one of the ranges of about 0.05 mm to 0.15 mm.

At this time, a vibration amount measured with respect to 5 test samples by rotating normal disks having no eccentric mass is denoted as a reference number 300. A reference number 320 is a vibration amount measured with respect to 5 test samples by rotating eccentric disk of 0.3 g·cm.

In the present disclosure compared with the comparative embodiment, the ball has a diameter of about 2.5 mm that is the same as the comparative embodiment, and at least one of the first gap Gr and second gap Gz is optimized to be about 10% to 20% of the diameter of the ball 240, that is, about 0.24 mm to 0.5 mm. In order to reduce the number of the test, the first gap Gr is set as about 0.4 mm and the second gap Gz is set as about 0.3 mm, both numbers being arbitrarily selected values.

Referring to FIG. 3, a vibration amount measured with respect to 5 test samples by rotating normal disk having no eccentric mass is denoted as a reference number 310. A reference number 330 is a vibration amount measured with respect to 5 test samples by rotating eccentric disks of 0.3 g·cm.

When comparing the present disclosure and the comparative embodiment, a performance of the ball balancer 200 including the lace 210 and the ball 240 according to the present disclosure is superior to that of the comparative embodiment in both normal disk and eccentric disk.

Accordingly, it is possible to largely decrease the vibration occurring in the spindle motor by controlling the gap between the inner side of the lace 210 of the ball balancer 200 and the surface of the ball balancer 240 inserted into the lace 210.

Hereinbefore, while the embodiments of the present disclosure are described, they are exemplary ones only and one of ordinary skill in the art may recognize that various alterations and modifications that fall within the scope of the present disclosure may be possible. Accordingly, the true technical protection scope of the present disclosure should be defined by the following claims.

What is claimed is:

1. A spindle motor comprising:
a turn table on which a disk is mounted;
a rotation shaft that is a rotational center of the turn table; and
a ball balancer including a lace formed on the turn table and a ball stored in the lace in order to reduce a rotation vibration of the disk;
wherein a gap Gr formed between the ball contacting an inner surface of the lace adjacent to the rotation shaft and an outer surface of the lace facing the inner surface is about 10% to 20% of the diameter of the ball.

2. The spindle motor according to claim 1, further comprising a cover that covers an opening of the lace configured to store the ball, in order to prevent the ball from leaving the lace.

3. The spindle motor according to claim 2, wherein the cover covers the lace that is opened in the lower direction of the turn table.

4. The spindle motor according to claim 1, wherein the ball balancer is integrally formed with the turn table.

5. The spindle motor according to claim 1, wherein the ball balancer is separated from the turn table.

6. A spindle motor comprising:
a turn table on which a disk is mounted;
a rotation shaft that is a rotational center of the turn table; and
a ball balancer including a lace formed on the turntable, a ball stored in the lace, a cover to cover the lace and a friction member interposed between the ball and the cover, in order to reduce a rotation vibration of the disk;
wherein a gap Gz formed between the ball arranged on the friction member and the top plane of the lace contacting the friction member is about 10% to 20% of the diameter of the ball.

7. The spindle motor according to claim 6, wherein the ball balancer is integrally formed with the turn table.

8. The spindle motor according to claim 6, wherein the ball balancer is separated from the turn table.

9. A spindle motor comprising:
a turn table on which a disk is mounted;
a rotation shaft that is a rotational center of the turn table; and
a ball balancer including a lace formed on the turntable, a ball stored in the lace, a cover to cover the lace and a friction member interposed between the ball and the cover, in order to reduce a rotation vibration of the disk;
wherein a gap Gr formed between the ball contacting an inner surface of the lace adjacent to the rotation shaft and an outer surface of the lace facing the inner surface and a gap Gz formed between the ball arranged on the friction member and the top plane of the lace contacting the friction member are about 10% to 20% of the diameter of the ball, respectively.

10. The spindle motor according to claim 9, wherein the ball balancer is integrally formed together with the turn table.

11. The spindle motor according to claim 9, wherein the ball balancer is separated from the turn table.
